(19) United States
(12) Patent Application Publication
(10) Pub. No.: US 2009/0014421 A1
(43) Pub. Date: Jan. 15, 2009

(54) Weld Repair Method for a Turbine Bucket Tip

(76) Inventors: Sujith Sathian, Greer, SC (US); Michael Douglas Arnett, Greenville, SC (US); Gene A. Murphy, Pelzer, SC (US)

Correspondence Address: NIXON & VANDERHYE P.C., 901 NORTH GLEBE ROAD, 11TH FLOOR, ARLINGTON, VA, 22203, US

(21) Appl. No.: 11/775,466

(22) Filed: Jul. 10, 2007

(51) Int. Cl. B23K 9/167; B23K 28/00

(52) U.S. Cl. 219/75

(57) ABSTRACT

A weld repair method uses a gas tungsten or plasma arc welding torch and matching filler. An amperage supplied to the torch and a travel speed of the torch are controlled to produce a weld bead having a mushroom shape. The weld bead is ground from all sides to remove at least one half of a thickness of the weld bead, and another weld bead is formed. The technique produces crack free welds with directionally solidified weld metal that is similar to that of the base material and hence has comparable mechanical properties.

### BACKGROUND OF THE INVENTION

The invention relates to a weld technique for repairing a turbine bucket tip and, more particularly, to a mushroom weld repair technique for repairing a latter stage directionally solidified bucket tip using a gas tungsten (GTAW) or plasma (PAW) arc welding process with matching chemistry filler wire. The weld technique can also be leveraged to other latter stage buckets and can be easily adopted among welding repair shops.

Directionally solidified buckets of a superalloy identified as GTD-444, so called DS GTD-444 buckets, are used as latter stage buckets for high efficiency engines such as the General Electric models FB and H engines. The directionally solidified GTD-444 buckets typically exhibit better creep resistance properties. In many instances, these buckets require repair at their tip by welding. On new make parts, it may be from mis-grinding/mis-machining, and on service buckets from tip wear or rubs against honeycomb during engine operation.

It is well known that the weldability of GTD-444 superalloy is extremely poor since this alloy contains higher gamma prime (approx. 60%) in the matrix. Therefore, welding produces unacceptable cracking in the base metal heat affected zone and in the weld metal. Some of the previous weld repair attempts using matching chemistry filler produced severe cracking in the weld and base metal heat affected zone (HAZ). General Electric service shops use a GTAW process for buckets cast from alloy 738 and equiaxed GTD-111. At this time, there is no known weld repair procedure to repair GTD-444 bucket tips.

Design engineering requires that the repair weld provide matching mechanical properties to that of the base material for better performance. Matching properties could only be achieved by using matching filler material such as Rene 142 or Rene 108. However, cracking susceptibility increases when these matching filler materials are used. In many cases, a ductile filler such as IN 617 or IN 625 will produce crack free welds, but it has significantly inferior properties and thus is undesirable. In all cases, the weld metal consists of equiaxed solidified dendrites within the weld metal that has inferior weld properties as compared to the base material substrate

It would be desirable to develop a repair technique/method for latter stage DS GTD-444 bucket tips that would produce crack free welds using matching base material properties using a GTAW process.

### BRIEF DESCRIPTION OF THE INVENTION

In an exemplary embodiment, a weld repair method uses a gas tungsten (GTAW) or plasma arc welding (PAW) torch and matching filler. The method includes the steps of (a) controlling an amperage supplied to and a travel speed of the torch to produce a weld bead having a mushroom shape; (b) grinding the weld bead from all sides to remove at least one half of a thickness of the weld bead; (c) repeating step (a); and (d) repeating step (b).

In another exemplary embodiment, the method includes the steps of (a) creating a solidification front that is parallel to the base material with the welding torch and a shaped weld bead, wherein the shaped weld bead includes directionally solidified weld metal at a center surrounded by equiaxed structure; (b) removing substantially all of the equiaxed structure; (c) repeating step (a); and (d) repeating step (b) and restoring the base material substantially to its original dimensions.

### BRIEF DESCRIPTION OF THE DRAWINGS

FIG. 1 is a schematic of the weld repair technique procedure; and

FIG. 2 illustrates the concept of the weld repair technique.

### DETAILED DESCRIPTION OF THE INVENTION

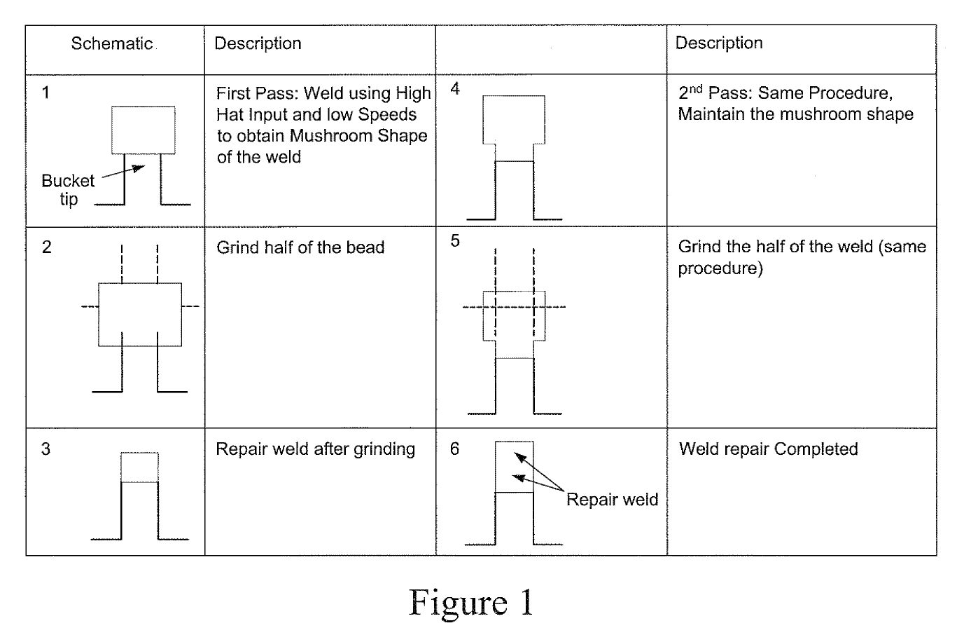

The weld repair technique procedure of an exemplary embodiment will be described with reference to FIG. 1. A DS GTD-444 bucket tip is first pre-heated to 1000° F. in a wrap box in an inert gas atmosphere, such as Argon, Helium, or the like. Typical heating rates that in a wrap box are 50° F./minute from room temperature to 1500° F. or 25° F./minute to a maximum temperature of 1900° F. Induction heating may also be used. Rene 142-Hf filler wire may be selected to repair the tip since its chemistry is close to GTD-444 superalloy base material. Note that GTD-444 filler wire is not available at this time. Other suitable high strength matching welding filler materials may include GTD 111, Rene 80, Rene 108 and the like. A GTAW process or a PAW process is used for the weld repair technique.

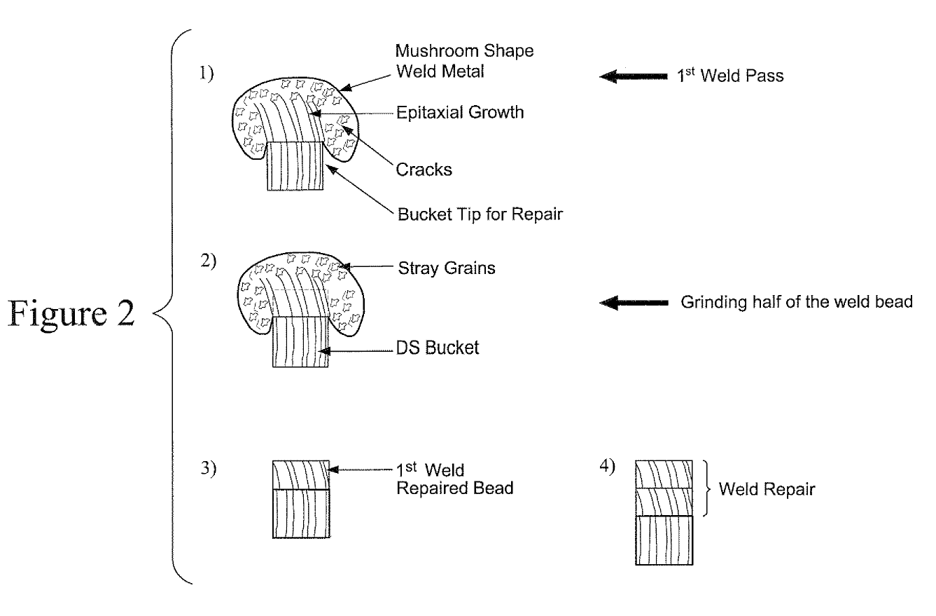

In a first step, the amperage and travel speed of the GTAW torch are controlled manually in such a way as to produce a weld bead with a “mushroom” shape. As shown in FIG. 2, the mushroom shape is wider and taller than the bucket tip dimension, with sides and a rounded upper portion.

Following welding, the weld bead is ground from all sides. The amount of material removed is approximately one half of the weld bead deposited on all sides. A subsequent pass is welded on top of the ground surface using the same weld parameters, again so as to produce a “mushroom” shaped weld bead.

The grinding operation is carried out again after welding the second pass, restoring the tip to its original dimensions. The final repair weld is shown in FIG. 1.

The idea for maintaining the mushroom weld shape is to create a solidification front that is parallel to the bucket tip. This produces directionally solidified grains nucleated from the tip and propagating to the weld bead surface. It is difficult to control the solidification front in the weld metal, since welding is a non-equilibrium process. Therefore, after some initial directionally solidified grain growth in the first weld pass, the weld pool thermal gradient decreases as the distance from the weld fusion line increases, resulting in nucleation of equiaxed grains within the outer layer of weld metal. The final structure includes directionally solidified weld metal at the center, surrounded by equiaxed structure. This can be seen in a transverse macro section of the weld.

It is noted that most occurrences of cracking are associated with equiaxed structure in the weld metal, which thus is highly detrimental as far as weldability is concerned. Removal of the half of the weld bead by grinding prior to each subsequent pass removes almost all of the equiaxed grains produced by the welding operation. The same process is repeated for multi-pass welding. Therefore, this technique will produce weld metal with directionally solidified structure that is free of cracks.

Exemplary weld parameters which were used for test welding the bucket are listed below:

Current: 22-30 amps

Voltage: 10-12 volts as needed to maintain molten bead front

Air Flow rate (Wrap): 250-300 SCFH as required to avoid oxidation of weld bead

Filler Wire diameter: 0.045″-0.062″

Precautions: Buildup of “mushroom” bead at start of pass must be performed slowly to avoid excessive melting of base material or with the use of starting tab. Additional filler material or a stop tab could be used to avoid crater cracking at the end of the weld bead.

Using the weld repair technique described herein, a DS GTD-444 superalloy latter stage bucket tip can be repaired using a GTAW or PAW welding process. The process produces a weld that is crack free in the weldment, base material, and heat affected zone. Additionally, the technique uses matching chemistry filler that has similar mechanical properties in the base material. The resulting weld includes directionally solidified weld metal that is similar to the directionally solidified base material, resulting in a secure weld that is less susceptible to cracks. The weld technique can also be leveraged to other latter stage buckets and can be easily adopted among welding repair shops.

Nominal chemical compositions of the identified Ni-based superalloys are provided in Table 1.

TABLE 1

| | GTD 111 | GTD 444 | Rene 108 | Rene 80 | Rene 142-Hf |
|---|---|---|---|---|---|
| | Alloy A | Alloy B | Alloy C | Alloy D | Alloy E |
| | avg | avg | avg | avg | avg |
| Co | 9.50 | 7.50 | 9.50 | 9.50 | 12.00 |
| Cr | 14.00 | 9.75 | 8.35 | 14.00 | 6.80 |
| Al | 3.00 | 4.20 | 5.50 | 3.00 | 6.10 |
| Ti | 4.90 | 3.50 | 0.75 | 5.00 | |
| Mo | 1.55 | 1.50 | 0.50 | 4.00 | 1.50 |
| Ta | 2.75 | 4.80 | 3.05 | | 6.30 |
| W | 3.80 | 6.00 | 9.50 | 4.00 | 4.90 |
| Nb | | 0.50 | | | |
| Re | | | | | 2.80 |
| Hf | | 0.15 | 1.50 | | |
| C | 0.100 | 0.08 | 0.085 | 0.17 | 0.12 |
| B | 0.013 | 0.00925 | 0.015 | 0.015 | 0.015 |
| Zr | | | 0.0125 | | |
| Ni | 60.4 | 62.01 | 61.24 | 60.32 | 57.97 |

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A weld repair method using a gas tungsten (GTAW) or plasma arc welding (PAW) torch and matching filler, the method comprising:
(a) controlling an amperage supplied to and a travel speed of the torch to produce a weld bead having a mushroom shape;
(b) grinding the weld bead from all sides to remove at least one half of a thickness of the weld bead;
(c) repeating step (a); and
(d) repeating step (b).

2. A method according to claim 1, further comprising, prior to step (c), repeating step (a) and repeating step (b).

3. A method according to claim 1, wherein the weld repair method is for a turbine bucket tip, and wherein the method further comprises, prior to step (a), preheating the bucket tip.

4. A method according to claim 3, wherein the preheating step is practiced in an atmosphere of inert gas.

5. A method according to claim 4, wherein the inert gas is one of Argon and Helium.

6. A method according to claim 1, wherein the weld repair method is for a turbine bucket tip, wherein the turbine bucket tip is formed of a directionally solidified superalloy, and wherein step (a) is practiced using a suitable filler wire.

7. A method according to claim 6, wherein the filler wire comprises filler wire formed of Alloy E.

8. A method according to claim 6, wherein the filler wire comprises one of Alloy A, Alloy C and Alloy D.

9. A weld repair method for a base material using a gas tungsten (GTAW) or plasma arc welding (PAW) torch and a matching filler, the method comprising:
(a) creating a solidification front that is parallel to the base material with the welding torch and a shaped weld bead, wherein the shaped weld bead includes directionally solidified weld metal at a center surrounded by equiaxed structure;
(b) removing substantially all of the equiaxed structure;
(c) repeating step (a); and
(d) repeating step (b) and restoring the base material substantially to its original dimensions.

10. A method according to claim 9, wherein step (a) is practiced such that the shaped weld bead is formed in a mushroom shape.

11. A method according to claim 10, wherein step (a) is further practiced by controlling an amperage supplied to and a travel speed of the torch to produce the weld bead having the mushroom shape.

12. A method according to claim 9, wherein step (b) is practiced by grinding the weld bead.
